(19) United States
(12) Patent Application Publication
(10) Pub. No.: US 2007/0230882 A1
(43) Pub. Date: Oct. 4, 2007

(54) ALL-OPTICAL POLARIZATION ROTATION SWITCH USING A LOOP CONFIGURATION

(76) Inventor: Rainer HAINBERGER, Wien (AT)

Correspondence Address: STAAS & HALSEY LLP, SUITE 700, 1201 NEW YORK AVENUE, N.W., WASHINGTON, DC, 20005, US

(21) Appl. No.: 11/568,379

(22) PCT Filed: Jul. 22, 2004
(86) PCT No.: PCT/JP04/10790

§ 371 Date: Oct. 26, 2006

(51) Int. Cl. G02B 6/00

(52) U.S. Cl. 385/122; 385/11

(57) ABSTRACT

All-optical polarization rotation switch is disclosed. A linearly polarized probe light is split by a polarization beam splitter (PBS) into two orthogonal linear polarization components, which are coupled with respective ends of a nonlinear optical fiber in loop configuration. A linearly polarized control pump light is launched into one direction of the fiber. The probe light component co-propagating with the control light pulse undergoes a nonlinear phase shift due to cross phase modulation (XPM). The phase shift of the light co-propagating with the control pulse thus causes a rotation of the recombined light output from the PBS. The rotation is detected by using a polarizer. Exploiting XPM instead of the nonlinear birefringence enables the use of highly nonlinear PM fiber.

### TECHNICAL FIELD

The invention relates to an all-optical polarization rotation switch using a loop structure.

### BACKGROUND ART

For ultra-high speed optical signal processing in optical transmission systems and networks, it is prerequisite that all-optical switches have a nonlinear relationship between control light power (Pcontrol) and output signal light power (Pout) as shown in FIG. 1. To date, various all-optical switching techniques have been proposed and demonstrated using the optical Kerr switch, nonlinear optical loop mirror (NOLM) switch, a pump-induced frequency-shift switch using cross phase modulation (XPM) and a four-wave mixing process. Among these switching techniques, an important type of all-optical switch providing such a nonlinear transfer function is the polarization rotation switch.

The conventional way to realize a polarization rotation switch is to exploit the nonlinear birefringence in optical fibers induced by a linearly polarized strong control pump light. FIG. 2A through 2C are diagrams showing a conventional polarization rotation switch that exploits nonlinear birefringence in a nonlinear fiber. In FIG. 2A, the conventional polarization rotation switch is comprised of a coupler 51 for coupling a first and a second input into a coupled output, a nonlinear fiber 53 having one end coupled to the port 51c of the coupler 51, a wavelength filter 55 having its one side optically coupled to the other end of the nonlinear fiber 53, and a polarizer 57 coupled to the other side of the wavelength filter 55.

In such a setup, a linearly polarized strong pump light (λ control) is input to a coupler port 51a, and a weak probe light (λ in) with a linear input polarization rotated by 45 degrees with respect to the polarization of the control pump light is input to a coupler port 51b. Then, the probe light and the control pump light output from a coupler port 51c are coupled to the nonlinear fiber 53. Since the change of refractive index in the plane of polarization of the control pump light (λ control) is larger than in the orthogonal plane, the polarization component collinear with the pump light polarization will experience a different phase shift than the orthogonal polarization component. This causes a rotation of the output polarization at the fiber 53 end. This rotation can be exploited for switching by placing the polarizer 57 at the fiber output end that blocks the linearly polarized probe light in absence of the pump light. As shown in FIG. 2C, the polarization direction by the polarizer 7 is set perpendicular to the polarization of the probe light (λ in), which enables only the light rotated by the pump light (λ control) to pass through the polarizer 7. In this way, the conventional polarization rotation switch can serve as a switch.

However, in order to be able to take advantage of the nonlinear birefringence, the nonlinear fiber has to be non-polarization maintaining with low polarization mode dispersion. PM-fibers (polarization-maintaining fibers) are not suitable because of the large walk-off between the two principle states of polarization in the fiber.

To date, some solutions have been proposed to cope with the polarization dependent group delay due to the fiber birefringence in polarization rotation switches. Three of them are as follows.

Morioka et al. described a birefringence compensation technique in an article “Ultrafast reflective optical Kerr demultiplexer using polarisation rotation mirror” in Electronics Letters, Volume 28, Issue 6, pp. 521-522 (12 Mar. 1992). In the technique, both pump and signal signals are reflected at the exit of a Kerr medium.

Morioka et al. proposed “Ultrafast polarisation-independent optical demultiplexer using optical carrier frequency shift through crossphase modulation” in Electronics Letters, Volume 28, Issue 11, pp. 1070-1072 (12 Mar. 1992). The demultiplexer uses XPM (cross phase modulation)—induced optical carrier frequency shift (frequency chirping), combined with a polarization rotation mirror consisting of a PBS (polarization beam splitter) and a polarization-maintaining (PM) fiber.

Morioka et al. also proposed “Polarisation-independent 100 Gbit/s all-optical demultiplexer using four-wave mixing in a polarisation-maintaining fiber loop” in Electronics Letters, Volume 30, Issue 7, pp. 591-592 (31 Mar. 1994). The demultiplexer uses FWM (four wave mixing) in a PM polarization rotating fiber loop mirror (PRLM).

It is an object of the invention to provide an alternative configuration that allows the use of polarization maintaining (PM) fibers with a larger differential group delay (difference of the propagation time of a pulse coupled into slow and fast axis).

### DISCLOSURE OF THE INVENTION

This invention provides an optical polarization rotation switch that does not exploit the nonlinear birefringence but the cross phase modulation (XPM) effect with control pump light and probe light having collinear polarization. This is made possible by using the birefringent nonlinear fiber in a loop configuration.

According to the invention, an all-optical polarization rotation switch is provided. The polarization rotation switch comprises a polarization beam splitter (14) for splitting a first light given through a first port thereof to output a first and a second orthogonal component from a second and a third port of the polarization beam splitter and for recombining a first and a second input light received from the second and third ports to output a recombined light from the first port; a nonlinear optical fiber (18), both ends of the nonlinear optical fiber being optically coupled with the polarization beam splitter so as to receive the first and second orthogonal components; a first optical portion (10) for launching a linearly polarized probe light toward the first port of the polarization beam splitter; a second optical portion (12, 16) for causing a linearly polarized pump light collinear to the linearly polarized probe light in polarization to propagate from the second port to the third port of the polarization beam splitter through the nonlinear optical fiber; a separating portion (22 or 30), provided in a light path from the first optical means to the first port of the polarization beam splitter, for separating, from the light path, the recombined light from the first port of the polarization beam splitter; and a detecting portion (24, 26) for passing only a rotated light caused by the first orthogonal component co-propagating with the linearly polarized pump light through the nonlinear optical fiber.

### BRIEF DESCRIPTION OF THE DRAWINGS

The invention is now described in closer detail in connection with the preferred embodiments with reference to the accompanying drawings in which

FIG. 1 is a diagram showing a nonlinear relationship between the control light power (Pcontrol) and the output light power (Pout);

FIG. 2 is a block diagram showing a conventional all-optical polarization rotation switch;

FIG. 3 is a schematic block diagram showing an exemplary arrangement of an all-optical polarization rotation switch in accordance with a first illustrative embodiment of the invention;

FIG. 4 is a diagram showing exemplary polarization states of the split out lights Lcw and Lccw and the control pump light Lcontrol;

FIG. 5 is diagrams showing the polarization states of the recombined light Lo α at PBS port 14a in case of the absence (FIG. 5A) and the presence (FIG. 5B) of a pulse in the control pump light Lcontrol or Lc;

FIG. 6A is a truth table showing an exemplary relationship among the input probe light (Lin), the control pump light (Lcontrol) and the output light (Lout);

FIG. 6B is a chart showing exemplary waveforms of the input probe light (Lin), the control pump light (Lcontrol) and the output light (Lout);

FIGS. 7 through 10 are schematic block diagrams showing exemplary arrangements of modifications of the all-optical polarization rotation switch of FIG. 3;

FIG. 11 is a schematic block diagram showing an exemplary arrangement of an all-optical polarization rotation switch in accordance with a second illustrative embodiment of the invention; and

FIGS. 12 and 13 are schematic block diagrams showing exemplary arrangements of modifications of the all-optical polarization rotation switch of FIG. 11.

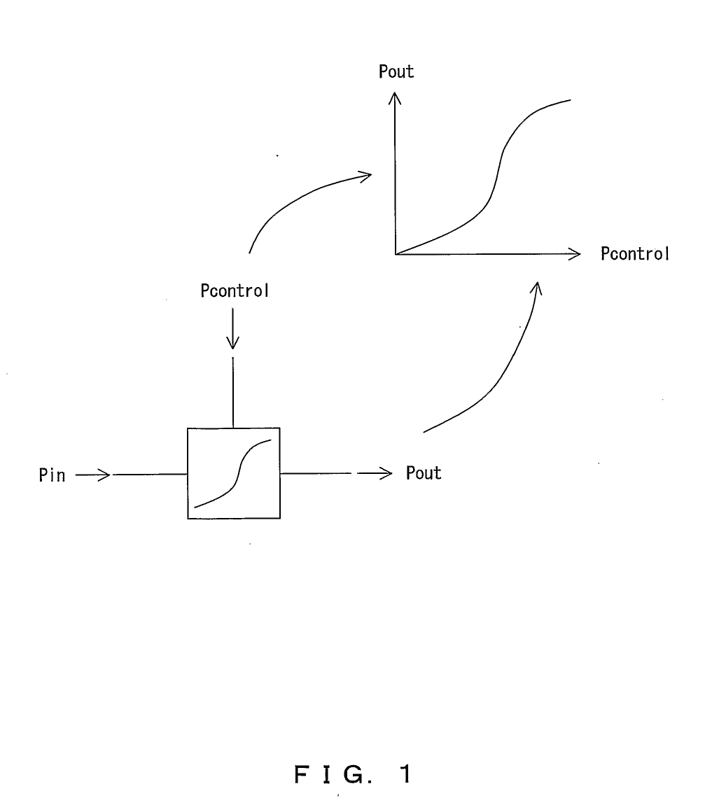

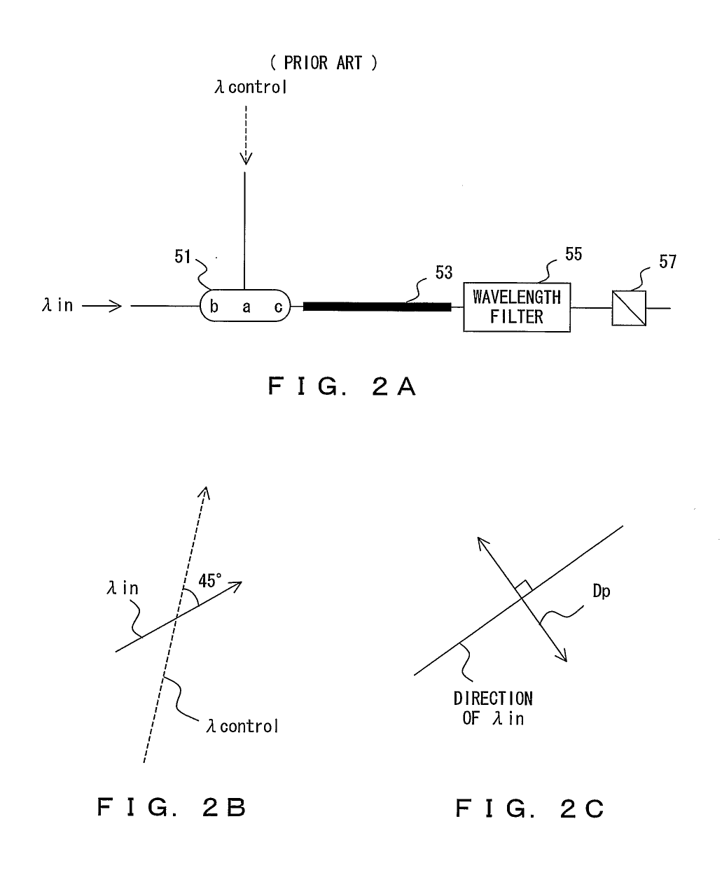

### BEST MODE FOR CARRYING OUT THE INVENTION

This invention provides an all-optical polarization rotation switch that does not exploit the nonlinear birefringence but the cross phase modulation (XPM) effect with control pump light and probe light having collinear polarization. This is made possible by using the birefringent nonlinear fiber in a loop configuration.

### Embodiment I

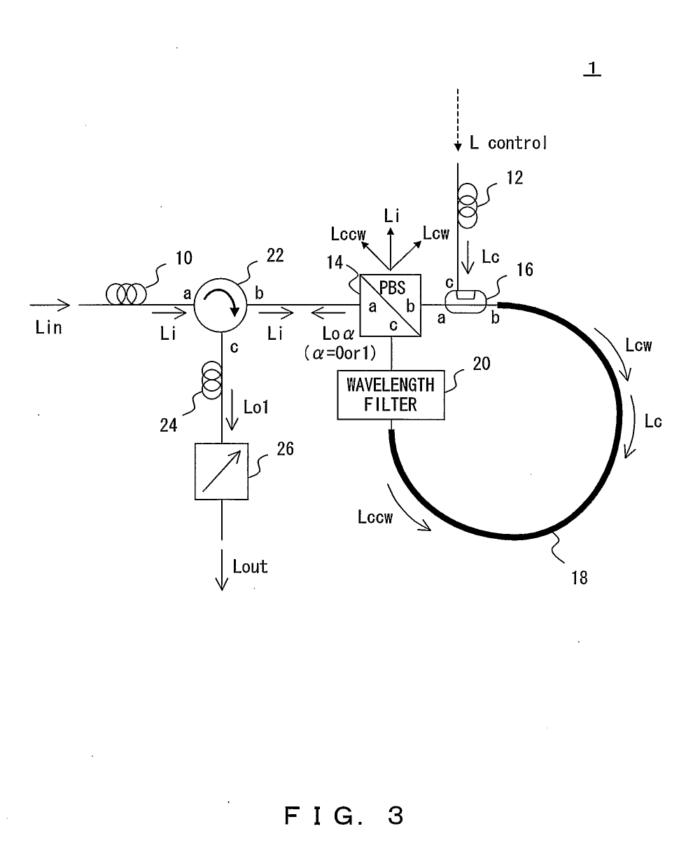

FIG. 3 is a schematic block diagram showing an exemplary arrangement of an all-optical polarization rotation switch in accordance with a first illustrative embodiment of the invention. In FIG. 3, the all-optical polarization rotation switch 1 comprises a polarization controller (PC) 10 that receives and linearly polarizes an input probe light from the external; a PC 12 that receives and linearly polarizes a control pump light or pulse Lcontrol from the external into a linearly polarized control pump light Lc; a polarization beam splitter (PBS) 14 having its port 14a is optically coupled with the PC 10; a directional coupler 16 which passes the split light output from a port 14b of the PBS 14 and couples the light received from a port 16c to a port 16b to which the passed split light is also coupled; a wavelength control filter 20 inserted just in front of a port 14c of the PBS 14; and a nonlinear fiber 18 in a loop configuration which optically connects a port 16b of the directional coupler 16 and the remaining end of the wavelength control filter 20.

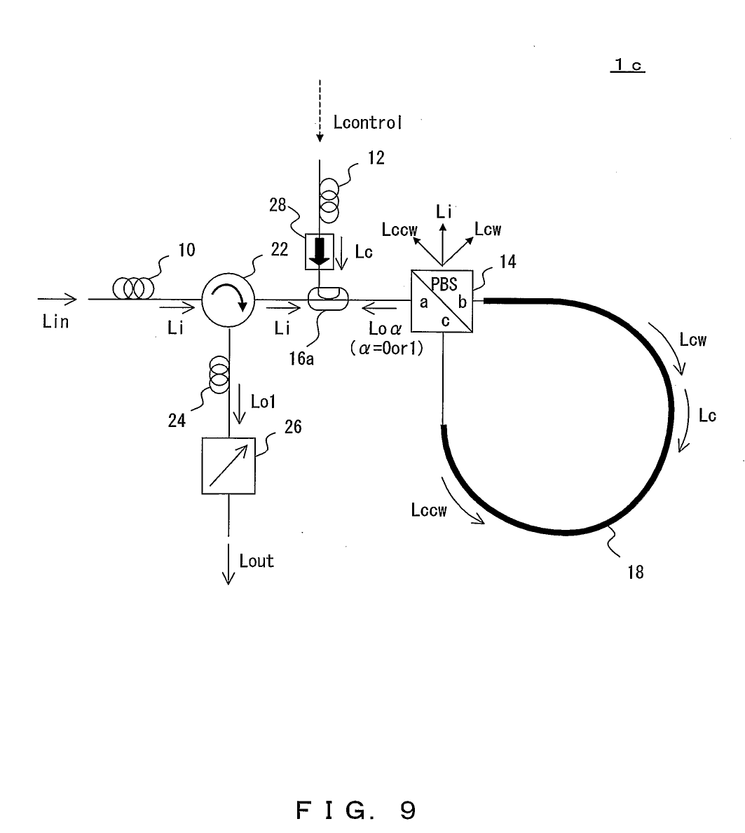

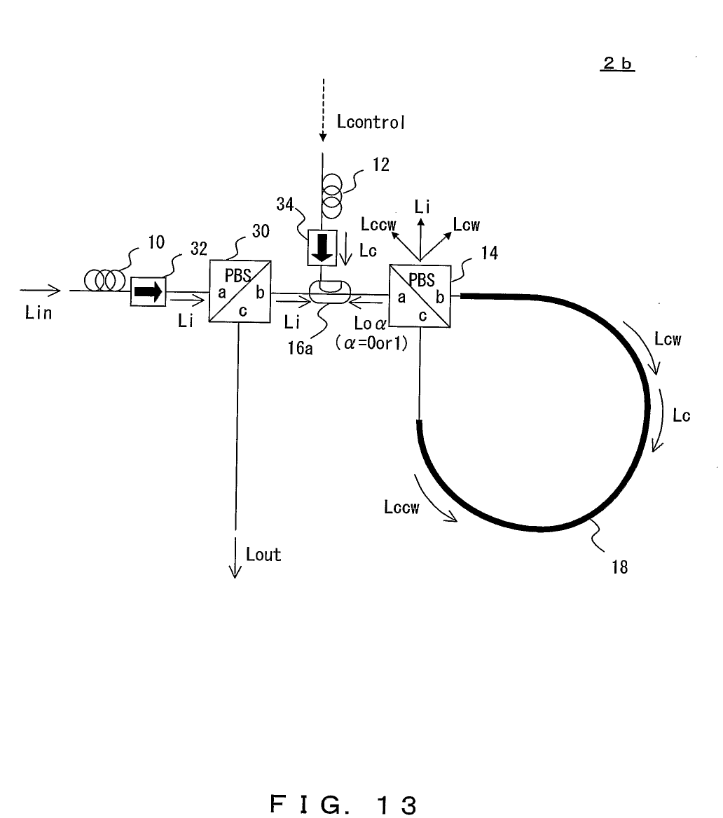

The directional coupler 16 maybe either a 3 dB (or 9:1) coupler that couples the two inputs with a defined coupling ration or a WDM (wavelength-division multiplexing) coupler. However, in case of configuration shown in FIG. 9 or 13, only WDM coupler is applicable as the directional coupler 16a.

The polarization rotation switch 1 further comprises an optical circulator 22 inserted via ports 22a and 22b between the PC 10 and the PBC 14, respectively; a PC 24 having one port is coupled to a port 22c of the optical circulator 22; and a polarizer 26 having one end coupled with the other port of the PC 24 and providing a polarized output from the other end. The above-mentioned components 10 through 26 are well known and accordingly we omit their details.

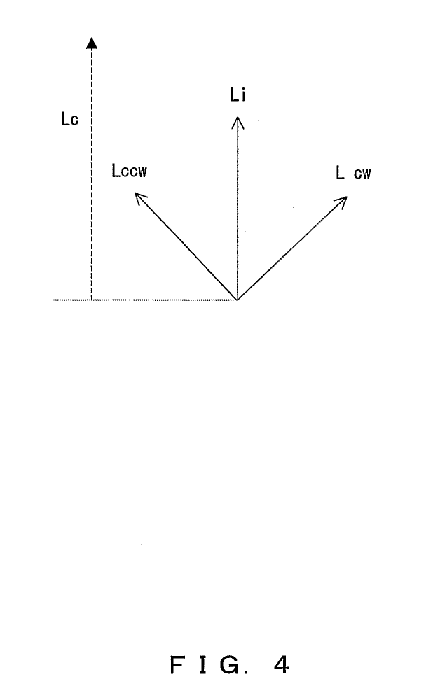

In operation, the input probe light Lin is linearly polarized (into a linearly polarized light Li) by means of a polarization controller (PC) 10. The probe light Li is preferably coupled to the input port 14a of the polarization beam splitter (PBS) 14 oriented 45° with respect to the probe light (Li) polarization. FIG. 4 shows how the PBS 14 works. Since the PBS 14 is arranged such that the multi-layered reflection films of the PBS are preferably at 45° with respective to the probe light (Li) polarization, the PBS 14 splits the probe light Li into two orthogonal linear polarization components Lcw and Lccw, which are substantially the same in the intensity. (The linearly polarized strong control pump light is shown on the left side of the vectors Li, Lcw and Lccw.) These two components Lcw and Lccw are output at ports 14b and 14c of the PBS 14, respectively. The two ends of the nonlinear fiber 18 are optically coupled to the PBS ports 14b and 14c (via directional coupler 16 and wavelength control filter 20) such that the linearly polarized light input Lcw at port 14b is output at the fiber end connected to port 14c with the output polarization collinear to the polarization of the light Lccw launched into the fiber at port 14c. Because of the reciprocity of the optical path, the output polarization of the light Lccw propagating from port 14c to 14b is also collinear with the polarization coupled into the fiber at port 14b. A quarter-lambda waveplate (not shown) can be employed either at port 14b or 14c to facilitate the alignment of the polarization. The two counter-propagating components Lcw and Lccw are recombined at the PBS 14 and output to port 14a. The output polarization of the recombined light Lo at port A is the same as the input polarization (of the input light Li) because both components propagating through the loop 18 experience the same phase delay. By launching a control pump light pulse Lc in one direction of the loop 18 by means of a directional coupler 16 with the polarization of the control light Lc collinear to that of the probe light Li as shown in FIG. 4, the probe light component Lcw co-propagating with the control light pulse Lc undergoes a nonlinear phase shift due to cross phase modulation (XPM). The phase of the counter-propagating probe light component Lccw remains almost unchanged.

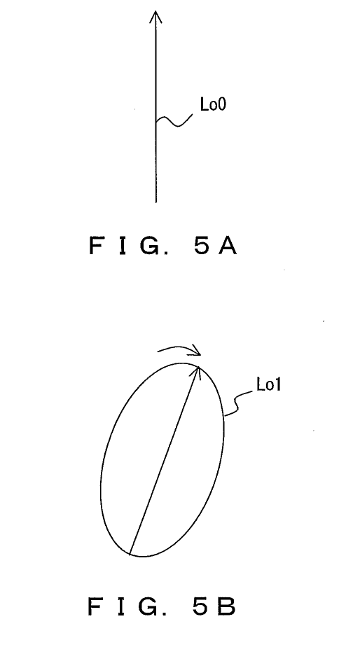

In FIG. 3, the recombined light at PBS port 14a is denoted as Lo α. Here, the suffix “α” a is replaced with 0 in case of the absence of a pulse in the control pump light Lc (or Lcontrol) and with 1 in case of the presence of a pulse in the control pump light Lc. If the probe light Lcw has propagated in the loop 18 in the absence of the control pump light Lc, then the probe light Lcw remains almost unchanged in the phase, which causes the PBS 14 to output from port 14a a recombined light Lo0 which is the same in the polarization state as the input probe light Li as seen from FIGS. 4 and 5A. If the probe light Lcw has propagated in the loop 18 in the presence of a control pump light or pulse Lc, then the probe light Lcw experiences a phase shift during the propagation, which causes a rotation of the recombined light output Lo1 at PBS port 14a as shown in FIG. 5B.

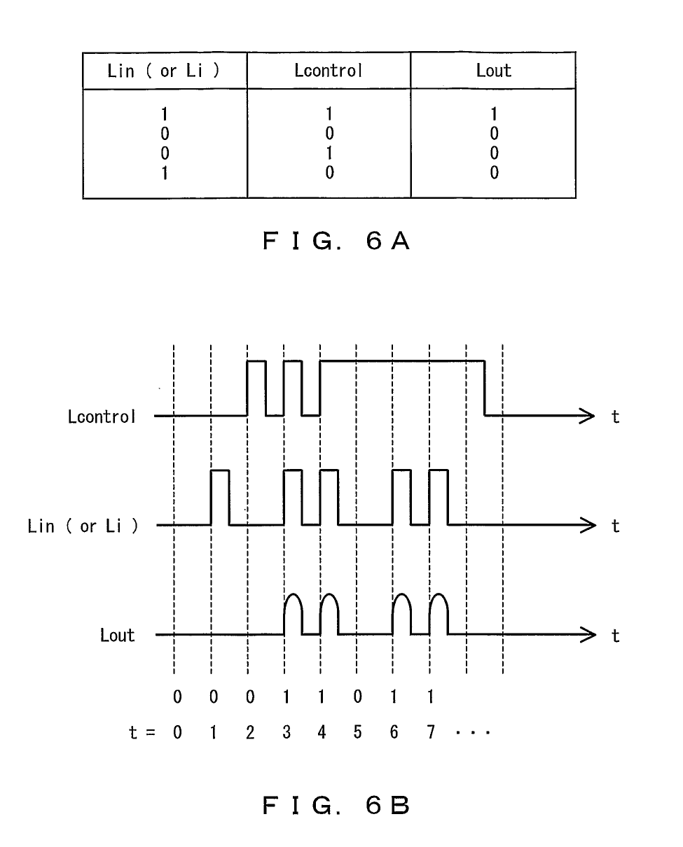

The optical circulator 22 in front of PBS port 14a is used to separate forward propagating input probe light Li and backward propagating output probe light Lo. The separated output probe light from the optical circulator 22 has its polarization adjusted by the polarization controller 24 and input to the polarizer 26. The polarization controller 24 and the polarizer 26 are so aligned as to suppress the output probe light Lo0 that does not undergo a rotation in the absence of the control pump light or pulse Lc (i.e., Lcontrol) as shown for time t=1 in FIG. 6B. In FIG. 6B, though the input probe light Lin is logical 1 at time 1, the output light Lout is logical 0 because of the absence of the control pump light Lcontrol. As seen from FIG. 6B, the all-optical polarization rotation switch 1 operates as the two-input AND gate. Thus, we obtain the truth table of FIG. 6A.

According to the invention, all-optical polarization rotation switching can be achieved without exploiting the nonlinear birefringence but by using the cross phase modulation (XPM) effect with control pump light and probe light having collinear polarization in a birefringent nonlinear fiber in a loop configuration.

Further, as the birefringent nonlinear fiber, any suitable polarization maintaining (PM) fiber may be used including new highly nonlinear photonic crystal fiber (PCF) If a PM fiber is used, all lights propagate in the same eigenaxis of the PM fiber. Using a highly nonlinear PM fiber enables a reduction in the switch size.

These features of the invention are also true to the following embodiment and modifications that are essentially based on the same principles of just described embodiment of the invention.

### Modifications of Embodiment 1

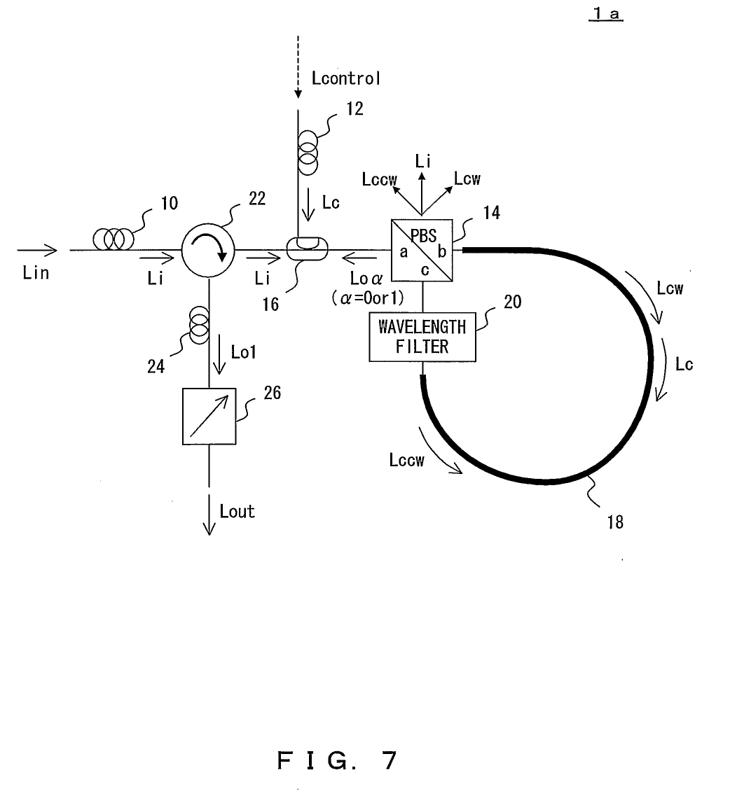

FIGS. 7 through 10 are schematic block diagrams showing exemplary arrangements of modifications of the all-optical polarization rotation switch of FIG. 3. In the following modifications, the directional coupler 16 for the pump light Lc is placed in front of the loop 18 instead inside the loop 18.

In FIG. 7, an all-optical polarization rotation switch 1a is identical to that of FIG. 3 except that the directional coupler 16 has been moved from the side 14b of the PBS 14 to between the optical circulator 22 and the PBS 14. The operation of the switch la is identical of that of FIG. 3 except that the linearly polarized control pump light Lc is coupled to the light path leading to the PBS port 14a.

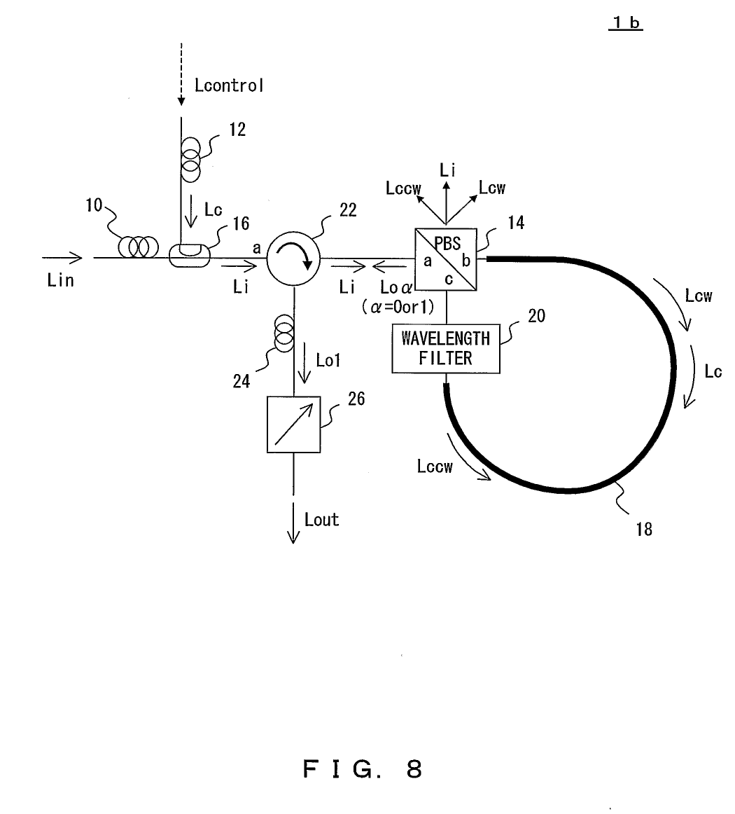

In the same way, in FIG. 8, an all-optical polarization rotation switch 1b is identical to that of FIG. 3 except that the directional coupler 16 has been moved from the side 14b of the PBS 14 to between the PC 10 and the optical circulator 22. The operation of the switch 1b is identical of that of FIG. 3 except that the linearly polarized control pump light Lc is coupled to the light path leading to the port 22a of optical circulator 22.

In FIG. 9, an all-optical polarization rotation switch 1c is identical to that (1a) of FIG. 7 except that the directional coupler has been changed from 16 to 16a; the wavelength filter 20 has been removed from the switch 1a and, instead, an isolator 28 has been inserted between the PC 12 and the directional coupler 16a. The isolator 28 is for blocking the recombined light Lo output from the PBS 14 from going toward the control pump light source (not shown) . As described above, the directional coupler 16a is a WDM coupler.

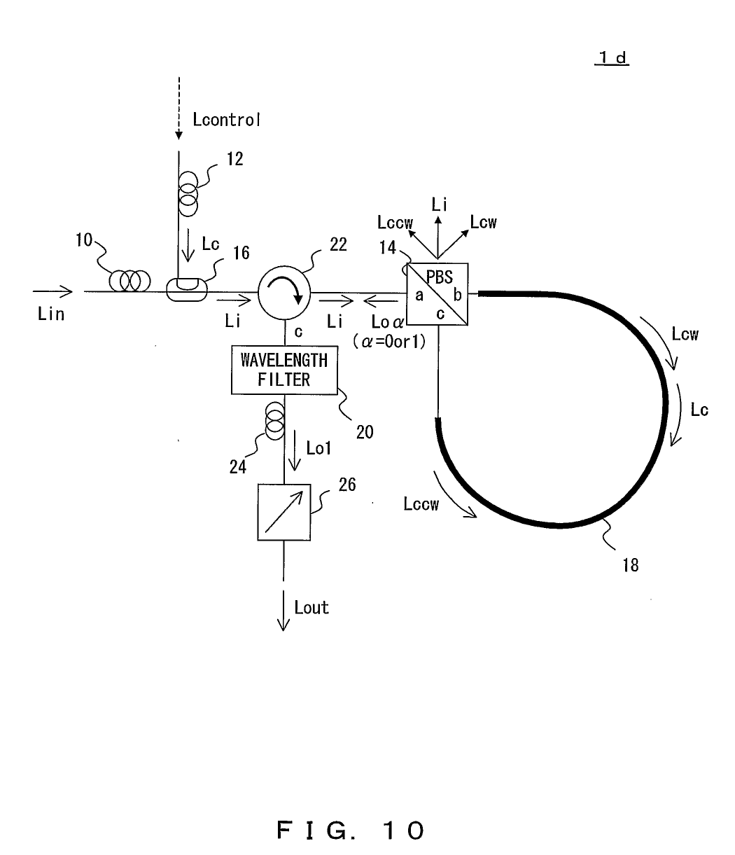

In FIG. 10, an all-optical polarization rotation switch id is identical to that (1b) of FIG. 8 except that the wavelength filter 20 has been placed outside the loop 18 and in the optical path behind the third port 22c of the optical circulator 22.

### Embodiment II

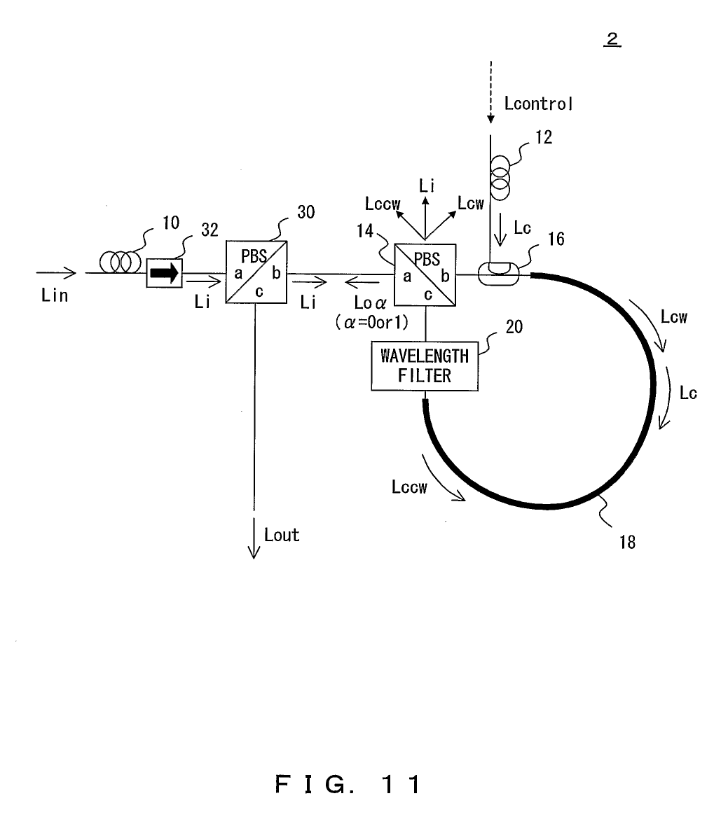

FIG. 11 is a schematic block diagram showing an exemplary arrangement of an all-optical polarization rotation switch in accordance with a second illustrative embodiment of the invention. In FIG. 11, the all-optical polarization rotation switch 2 is identical to that (1) of FIG. 3 except that
(1) the optical circulator 22 has been replaced with a PBS 30 with its eigenaxis collinear with the input probe light (Li) polarization;
(2) the optical circulator 24 and the polarizer 26 has been removed from the switch 1;
(3) an isolator 32 has been inserted between the CP 10 and the PBS 30.

The isolator 32 blocks the component of the backward propagating output probe light Lo0 that is not rotated. The orthogonal component of the rotated light Lo1 is coupled to the second port 30c of PBS 30.

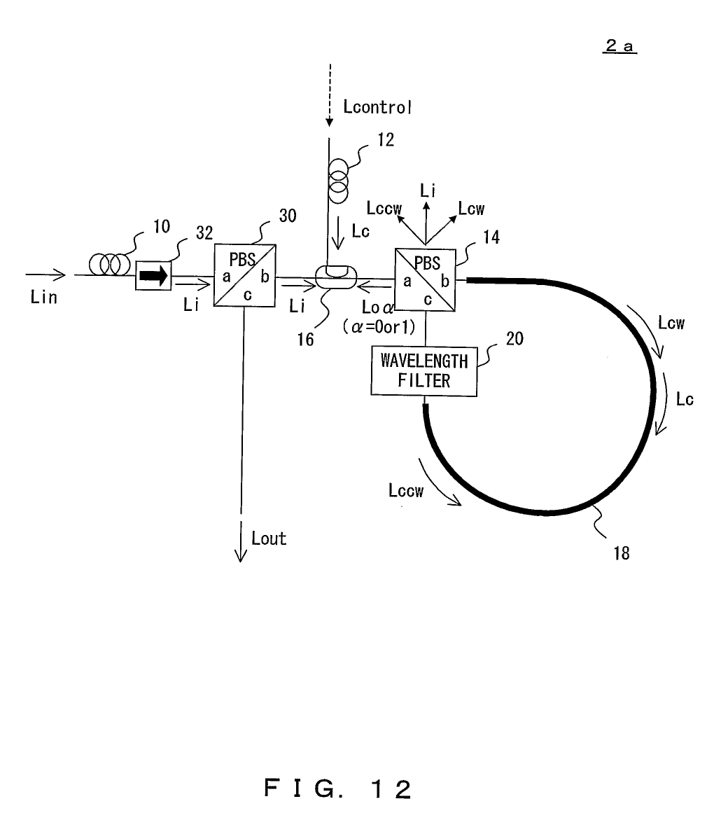

FIGS. 12 and 13 are schematic block diagrams showing exemplary arrangements of modifications of the all-optical polarization rotation switch 2 of FIG. 11.

In FIG. 12, an all-optical polarization rotation switch 2a is identical to that (2) of FIG. 11 except that the directional coupler 16 has been moved from the side 14b of the PBS 14 to between the PBS 30 port 30b and the PBS 14 port 14a. The operation of the switch 2 is identical of that 2 of FIG. 11 except that the linearly polarized control pump light Lc is coupled to the optical path leading to the PBS port 14a.

In FIG. 13, an all-optical polarization rotation switch 2b is identical to that (2a) of FIG. 12 except that the directional coupler has been changed from 16 to 16a; and the wavelength filter 20 has been omitted and an isolator 34 has been inserted in the pump light path in front of the directional coupler 16a. The isolator 28 blocks the recombined light Lo output from the PBS 14 from going toward the control pump light source (not shown). As described above, the directional coupler 16a is a WDM coupler.

The above-described embodiments and modifications are only for illustration. Many other modifications are possible to those who are ordinary skilled in the art without departing the scope of the invention.

For example, a quarter-lambda wave plate may be employed either at port 14b or 14c of the PBS 14 to facilitate the alignment of the polarization.

In the above-described embodiments and modifications, the control pump light is substantially collinear to the probe light. However, another type of operation of an inventive all-optical polarization rotation switch is to input the pump light in the orthogonal state with respect to the co-propagating probe light. This type of operation is of interest as it has the potential to overcome the problem of walk-off between the two principle states of polarization due to group velocity dispersion.

1-14. (canceled)

15. A polarization rotation switch, comprising:
a polarization beam splitter for splitting a first light given through a first port thereof to output first and second orthogonal components from second and third ports of said polarization beam splitter and for recombining first and second input light received from said second and third ports to output a recombined light from said first port;
a nonlinear optical fiber, both ends of said nonlinear optical fiber being optically coupled with said polarization beam splitter so as to receive said first and second orthogonal components;
first optical means for launching a linearly polarized probe light toward said first port of said polarization beam splitter;
second optical means for causing a linearly polarized pump light collinear to said linearly polarized probe light in polarization to propagate from said second port to said third port of said polarization beam splitter through said nonlinear optical fiber;
separating means, provided in a light path from said first optical means to said first port of said polarization beam splitter, for separating, from said light path, said recombined light from said first port of said polarization beam splitter; and
detecting means for passing only a rotated light caused by said first orthogonal component co-propagating with said linearly polarized pump light through said nonlinear optical fiber.

16. A polarization rotation switch as defined in claim 15, further comprising:
a wavelength filter arranged in such a manner that, at said third port of said polarization beam splitter, said second input light has an input polarization collinear to a polarization of said second orthogonal component, wherein said second optical means comprises:
a polarization controller for linearly polarizing a control pump light into said linearly polarized pump light, a polarization of said linearly polarized pump light being collinear to that of said linearly polarized probe light; and
coupling means for launching said linearly polarized pump light into a direction which is the same as a direction from said first port to said second port of said polarization beam splitter,
wherein said separating means is an optical circulator, and
wherein said detecting means comprises a polarization controller and a polarizer which are serially coupled.

17. A polarization rotation switch as defined in claim 16, wherein said coupling means is inserted between said second port of said polarization beam splitter and said nonlinear optical fiber.

18. A polarization rotation switch as defined in claim 16, wherein said coupling means is inserted in said light path.

19. A polarization rotation switch as defined in claim 16, wherein said coupling means is inserted in said light path between said first optical means and said first port of said polarization beam splitter.

20. A polarization rotation switch as defined in claim 15, wherein said nonlinear optical fiber is a polarization-maintaining fiber where all lights propagate in a same eigenaxis of the polarization-maintaining fiber.

21. A polarization rotation switch as defined in claim 15, wherein said second optical means is inserted in said light path between said separating means and said first port of said polarization beam splitter, and said second optical means comprises:
a polarization controller for linearly polarizing a control pump light into said linearly polarized pump light, a polarization of said linearly polarized pump light being collinear to that of said linearly polarized probe light;
means for blocking said recombined light from said first port from going toward said polarization controller, and
coupling means for launching said linearly polarized pump light into a direction which is the same as a direction from said first port to said second port of said polarization beam splitter,
wherein said separating means is an optical circulator, and
wherein said detecting means comprises a polarization controller and a polarizer which are serially coupled.

22. A polarization rotation switch as defined in claim 15, wherein said second optical means is inserted in said light path between said first optical means and said separating means, and said second optical means comprises:
a polarization controller for linearly polarizing a control pump light into said linearly polarized pump light, a polarization of said linearly polarized pump light being collinear to that of said linearly polarized probe light; and
coupling means for launching said linearly polarized pump light into a direction which is the same as a direction from said first port to said second port of said polarization beam splitter, wherein
said separating means is an optical circulator, and wherein said detecting means receives said recombined light from said separating means and comprises a serial connection of a wavelength filter, a polarization controller and a polarizer disposed in a stated order.

23. A polarization rotation switch as defined in claim 15, further comprising a wavelength filter arranged in such a manner that, at said third port of said polarization beam splitter, said second input light has an input polarization collinear to a polarization of said second orthogonal component, wherein said second optical means comprises:
a polarization controller for linearly polarizing a control pump light into said linearly polarized pump light, a polarization of said linearly polarized pump light being collinear to that of said linearly polarized probe light; and
coupling means for launching said linearly polarized pump light into a direction which is the same as a direction from said first port to said second port of said polarization beam splitter, wherein
said separating means comprises a second polarization beam splitter with its eigenaxis collinear with a polarization of said linearly polarized probe light, and wherein said detecting means is realized by a combination of:
said second polarization beam splitter; and
an isolator, inserted in said light path between said first optical means and said second polarization beam splitter, for blocking said second orthogonal component from going toward a probe light source.

24. A polarization rotation switch as defined in claim 23, wherein said coupling means is inserted between said second port of said polarization beam splitter and said nonlinear optical fiber.

25. A polarization rotation switch as defined in claim 23, wherein said coupling means is inserted in said light path in front of said first port of said polarization beam splitter.

26. A polarization rotation switch as defined in claim 25, wherein said second optical means further includes a second isolator, provided between said polarization controller and said coupling means, for blocking light propagation toward said polarization controller.

27. A polarization rotation switch as defined in claim 23, wherein said nonlinear optical fiber is a polarization-maintaining fiber where all lights propagate in a same eigenaxis of said polarization-maintaining fiber.

28. A polarization rotation switch as defined in claim 15, further comprising:
a quarter-lambda plate, provided at or near one of said second and third ports of said polarization beam splitter for facilitating an alignment of polarization between incoming and outgoing lights to and from said one port.

29. A polarization rotation switch, comprising:
a polarization beam splitter splitting a first light given through a first port thereof to output first and second orthogonal components from second and third ports of said polarization beam splitter and recombining first and second input light received from the second and third ports to output a recombined light from the first port;
a nonlinear optical fiber having two ends, both optically coupled with said polarization beam splitter so as to receive the first and second orthogonal components;
a first polarization controller supplying a linearly polarized probe light toward the first port of said polarization beam splitter;
a directional coupler coupling the second port of said polarization beam splitter and said nonlinear optical fiber;
a second polarization controller, coupled to said directional coupler, causing said directional coupler to supply a linearly polarized pump light collinear to the linearly polarized probe light in polarization to propagate from the second port to the third port of said polarization beam splitter through said nonlinear optical fiber;
an optical circulator, provided in a light path from said first polarization controller to the first port of said polarization beam splitter, separating, from the light path, the recombined light from the first port of said polarization beam splitter; and
a third polarization controller serially coupled to a polarizer passing only a rotated light caused by the first orthogonal component co-propagating with the linearly polarized pump light through said nonlinear optical fiber.

30. A polarization rotation switch, comprising:
a first polarization beam splitter splitting a first light received at a first port thereof to output first and second orthogonal components from second and third ports of said polarization beam splitter and recombining first and second input light received from the second and third ports to output a recombined light from the first port;
a nonlinear optical fiber having two ends, both optically coupled with said polarization beam splitter so as to receive the first and second orthogonal components;
a first polarization controller supplying a linearly polarized probe light toward the first port of said polarization beam splitter;
an optical circulator, provided in a light path from said first polarization controller to the first port of said polarization beam splitter, separating, from the light path, the recombined light from the first port of said polarization beam splitter;
a second polarization beam splitter between said first polarization controller and said first polarization beam splitter, having an eigenaxis collinear with a polarization of the linearly polarized probe light, a first port receiving the linearly polarized probe light, a second port outputting the linearly polarized probe light and receiving recombined light output from said first polarization beam splitter, and a third port outputting a rotated light caused by the first orthogonal component co-propagating with the linearly polarized pump light through said nonlinear optical fiber; and
an isolator in a light path between said first polarization controller and said second polarization beam splitter, blocking the second orthogonal component from going toward said first polarization beam splitter.
